(19) United States
(12) Patent Application Publication
(10) Pub. No.: US 2017/0021677 A1
(43) Pub. Date: Jan. 26, 2017

(54) Tire Including A Knitted Fabric Having Variable Properties

(71) Applicants: COMPAGNIE GENERALE DES ETABLISSEMENTS MICHELIN, Clermont-Ferrand Cedex (FR); Michelin Recherche et Technique, S.A., Granges-Paccot (CH)

(72) Inventors: Christophe LE CLERC, Clermont-Ferrand Cedex 9 (FR); Richard CORNILLE, Clermont-Ferrand Cedex 9 (FR); Geneviève PINEAU, Clermont-Ferrand Cedex 9 (FR); Xavier LEGRAND, Clermont-Ferrand Cedex 9 (FR); Hubert OSTYN, Clermont-Ferrand Cedex 9 (FR); Marc-Antoine COLOT, Clermont-Ferrand Cedex 9 (FR); Guillaume TANCHAUD, Clermont-Ferrand Cedex 9 (FR)

(21) Appl. No.: 15/300,949

(22) PCT Filed: Nov. 27, 2014
(86) PCT No.: PCT/EP2014/075762

§ 371 Date: Sep. 30, 2016

(30) Foreign Application Priority Data
Apr. 1, 2014 (FR) 1452855

(51) Int. Cl. B60C 13/00; B29D 30/72; B60C 15/00; B60C 9/18; B29D 30/38; B60C 1/00

(52) U.S. Cl. CPC B60C 13/003; B29D 30/38; B60C 1/0025; B60C 15/0009; B60C 9/18; B29D 30/72; B29D 2030/722

(57) ABSTRACT

Tire (10) comprises a knit (44) comprising: columns of loops, the loops of one and the same column being arranged one after the other substantially in an overall direction referred to as the main direction and rows of said loops, the loops of one and the same row being arranged one beside the other substantially in an overall direction referred to as the transverse direction. The knit (44) comprises first and second zones (45₁, 45₂), each respectively having, at least in one of the main or transverse directions, a force FT₁₀₀ and FS₁₀₀ at 100% elongation that satisfies FS₁₀₀<FT₁₀₀, each force FT₁₀₀ and FS₁₀₀ being determined from a force-elongation curve obtained by applying standard ISO 13934-1:2013 to the knit before it is incorporated into the tire (10).

The subject of the invention is a tire comprising a knit and a method of manufacturing such a tire.

The invention applies to any type of vehicle but is preferably intended for passenger vehicles, two-wheeled vehicles such as motor cycles or bicycles, industrial vehicles selected from vans, heavy vehicles such as “heavy duty vehicles”—i.e. underground trains, buses, road haulage vehicles (lorries, tractors, trailers), off-road vehicles, agricultural vehicles or civil engineering plant, aircraft, other transport or handling vehicles.

A tire for a passenger vehicle comprising a carcass reinforcement anchored in two beads and surmounted radially by a crown comprising a crown reinforcement and a tread, the latter being connected to the beads by two sidewalls, is known from WO2013017327. The tire comprises an additional reinforcement, notably arranged in the sidewall, and comprising a knit. When the tire is built, the knit, because of its elasticity, advantageously deforms with the deformation imposed by the shaping of the tire.

However, during this shaping, the various zones of the tire are not shaped identically. Specifically, the various zones are deformed between a state at rest and a shaped state. The degree of shaping, namely the relative difference between the dimensions in the shaped state and in the at rest state differs according to the zones and this has the effect of imposing greater deformation in the knit in some zones in comparison with others. Thus, once shaped, the knit has zones in which it is more highly deformed than it is in others, this having the effect of differentiating the ability of the knit to reinforce, according to these zones.

Thus, the zones that are deformed the most during shaping admittedly have a greater ability to reinforce in comparison with the least-deformed zones (force is an increasing function of elongation), but a significant amount of the elongation has already been used up. Conversely, the zones deformed the least during shaping have a lesser ability to reinforce than the most-deformed zones, but retain a good reserve capacity for elongation.

It is an object of the invention to reduce the difference in the ability to reinforce and to elongate of the various zones of the knit which ability is generated during the shaping of the tire.

To this end, one subject of the invention is a tire comprising a knit comprising:
columns of loops, the loops of one and the same column being arranged one after the other substantially in an overall direction referred to as the main direction,
rows of loops, the loops of one and the same row being arranged one beside the other substantially in an overall direction referred to as the transverse direction,
the knit comprising first and second zones each respectively having, at least in one of the main or transverse directions, a force FT₁₀₀ and FS₁₀₀ at 100% elongation that satisfies FS₁₀₀<FT₁₀₀, each force FT₁₀₀ and FS₁₀₀ being determined from a force-elongation curve obtained by applying standard ISO 13934-1:2013 to the knit before it is incorporated into the tire.

Standard ISO 13934-1:2013 indicates how to obtain the force-elongation curve for a knit of the tire according to the invention. The standard indicates precisely how, from this force-elongation curve, to determine the elongation at break and the maximum force, notably defining the number of tests, the calculation, and how to express the results relating to these parameters. A person skilled in the art will be just as capable, using this force-elongation curve, of determining the forces at 50% and 100% elongation, of calculating and expressing the results relating to these parameters in exactly the same way. In particular, the force-elongation curve is produced for test specimens with a length equal to 100 mm and a width equal to 50 mm±0.5 mm. Where that has been impossible because of the dimensions of the test specimen, a test specimen has been manufactured that comprises two standard zones allowing the positioning of the tensile test jaws between which the zone that is to be characterized was interposed. The two standard zones have identical knit (notably the same structure, the same filamentary element) to the last column or last row of the zone that is to be characterized that it extends.

The force-elongation curves for the first and second zones are obtained on fabrics in isolation from the tire, before they are incorporated into the tire, which means to say without any elastomer matrix between the stitches of the knit.

By definition, a knit is a reinforcing element comprising stitches. Each stitch comprises a loop interlaced with another loop. Thus, a distinction is made between a knit which is a textile made up of stitches, and a woven fabric which is a textile comprising weft threads and warp threads, the weft threads being substantially parallel to one another and the warp threads likewise being substantially parallel to one another.

A distinction is made between weft-knitted knits and warp-knitted knits. In weft knits, the stitches are essentially formed in the direction in which the loops of one and the same row are arranged next to one another (across the width of the knit). In warp knits, the stitches are essentially formed in the direction in which the loops of one and the same column (wale) are arranged next to one another (along the length of the knit).

The knit may have different constructions. A construction means the way in which the threads that form a repeating pattern in the knit are interlaced. Constructions include, nonlimitingly, jersey, welted jersey, one 1×1 rib, polka rib, interlocked rib, moss stitch in the case of weft knits, and locknit and atlas in the case of warp knits.

Thanks to the knit having differentiated first and second zones, the tire according to the invention makes it possible to reduce the difference in the capacity of the various zones of the knit to reinforce and to elongate, which capacity is generated during the shaping of the tire.

When the second zone of the knit is arranged in a zone of the tire that experiences greater shaping than the zone of the tire in which the first zone of the knit is arranged, the knit of the tire according to the invention makes provision for the force FT₁₀₀ at 100% elongation of the first zone to be greater than the force FS₁₀₀ at 100% elongation of the second zone so that, given that the force (or the capacity to reinforce) is an increasing function of the elongation, for a given force (or a desired capacity to reinforce), the elongation of the first zone of the knit is less than the elongation of the second zone of the knit, it thus being possible for the latter zone to conform to the greater shaping of the tire in this zone.

For preference, each first and second zone has, respectively, at least in one of the main or transverse directions, a force FT₅₀ and FS₅₀ at 50% elongation that satisfies FS₅₀<FT₅₀, each force FT₅₀ and FS₅₀ being determined from a force-elongation curve obtained by applying standard ISO 13934-1:2013 to the knit prior to its incorporation into the tire.

Advantageously, FT₁₀₀ and FS₁₀₀ satisfy FT₁₀₀/FS₁₀₀>1.05, preferably FT₁₀₀/FS₁₀₀>1.10 and more preferably, FT₁₀₀/FS₁₀₀>1.15.

Advantageously, FT₁₀₀ and FS₁₀₀ satisfy FT₁₀₀/FS₁₀₀<2.00, preferably FT₁₀₀/FS₁₀₀<1.80 and more preferably FT₁₀₀/FS₁₀₀<1.60.

The forces at 50% and 100% elongation are measured on the bare knit prior to its incorporation into the tire.

Advantageously, the first zone of the knit has a radius of curvature less than the radius of curvature of the second zone of the knit.

Optionally, the second zone is arranged radially on the outside of the first zone.

In one embodiment, each force FT₁₀₀ and FS₁₀₀ at 100% elongation of each first and second zone is measured in a direction of the knit that is substantially parallel to the circumferential direction of the tire. This is because the circumferential direction is the direction in which the differences in degree of shaping are the greatest.

Specifically the first zone differs from the second zone in terms of at least one feature selected from the construction, the stitch size, the linear density of columns of stitches as measured in accordance with standard NF EN 14971, the linear density of rows of stitches as measured in accordance with standard NF EN 14971, the surface density of stitches as measured in accordance with standard NF EN 14971, or a combination of these features.

Further features may be used to differentiate the first and second zones, such as, for example, in instances in which the knit is made up of one or more filamentary elements, the nature of the material from which the filamentary elements are made. In particular, in the case of filamentary elements comprising multifilament strands which are overtwisted and then plied, the titre and the twist of these filamentary elements can be used as features that differentiate the first and second zones.

For preference, the main overall direction of the knit is substantially parallel to the radial direction of the tire.

For preference, the transverse overall direction of the knit is substantially parallel to the circumferential direction of the tire.

Advantageously, the main and transverse directions make, with respect to one another, an angle of between 75° and 105°, preferably between 85° and 95°.

In one embodiment, the number of stitches in the knit per unit area, measured in accordance with standard NF EN 14971, is less than or equal to 700 stitches·cm⁻², preferably less than or equal to 100 stitches·cm⁻² and more preferably less than 75 stitches·cm⁻².

In one embodiment, the number of stitches in the knit per unit area, measured in accordance with standard NF EN 14971, is greater than or equal to 5 stitches·cm⁻², preferably greater than or equal to 10 stitches·cm⁻² and more preferably greater than 15 stitches·cm⁻².

For preference, the knit is made up of one or more filamentary elements made from a nonelastomeric material.

Advantageously, the or each nonelastomeric material is selected from a polyester, a polyamide, a polyketone, a polyvinyl alcohol, a cellulose, a mineral fibre, a natural fibre or a mixture of these materials.

Examples of polyesters include polyethylene terephthalate (PET), polyethylene naphthalate (PEN), polybutylene terephthalate (PBT), polybutylene naphthalate (PBN), polypropylene terephthalate (PPT) or polypropylene naphthalate (PPN). Examples of polyamides include an alphatic polyamide such as nylon or an aromatic polyamide such as aramid. Examples of polyvinyl alcohol include Kraton®. Examples of celluloses include rayon. Examples of mineral fibres include glass fibres and carbon fibres. Examples of natural fibres include hemp or flax fibres.

Advantageously, the or each filamentary element comprises at least one multifilament strand comprising several elementary monofilaments.

In an alternative form in which the knit comprises a plurality of multifilament strands, all the multifilament strands are made from the same material. In another alternative form in which the knit comprises a plurality of multifilament strands, the multifilament strands are made from at least two different materials.

In one embodiment, each filamentary element comprises a single multifilament strand referred to as an overtwist comprising several elementary monofilaments.

In another embodiment, each filamentary element comprises several multifilament strands, each one referred to as an overtwist, each one comprising several elementary monofilaments and assembled together in a helix to form a plied yarn.

For preference, each filamentary element has a tenacity greater than or equal to 30 cN·dtex⁻¹. For example, filamentary elements made of PET have one of the order of 70 cN·dtex⁻¹ and filamentary elements made of aramid have a tenacity of the order of 200 cN·dtex⁻¹.

Advantageously, each multifilament strand comprises between 2 and 2,000 elementary monofilaments, preferably between 50 and 1,000 elementary monofilaments.

Advantageously, the diameter of each elementary monofilament ranges from 10 μm to 100 μm, preferably from 10 μm to 50 μm and more preferably from 12 μm to 30 μm. Such a diameter makes it possible to obtain a knit that is relatively flexible and therefore compatible with use in a tire.

In another embodiment, each filamentary element comprises, is preferably made up of, a single monofilament.

For preference, the knit is coated with a layer of a tackifying adhesive. The adhesive used is for example of the RFL (Resorcinol-Formaldehyde-Latex) type or, for example, as described in publications WO2013017421, WO2013017422, WO2013017423.

In the tire, the knit is preferably embedded in an elastomer matrix. An elastomer (or rubber, the two terms being synonymous) matrix means a matrix comprising at least one elastomer.

For preference, the elastomer is a diene elastomer. As is known, diene elastomers can be classified into two categories: “essentially unsaturated” or “essentially saturated”. The term “essentially unsaturated” is understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of alpha-olefins of the EPDM type do not come under the above definition and can especially be described as “essentially saturated” diene elastomers (low or very low content of units of diene origin, always less than 15%). Within the “essentially unsaturated” category of diene elastomers a “highly unsaturated” diene elastomer particularly means a diene elastomer having a content of units of diene origin (conjugated dienes) which is higher than 50%.

Although it is applicable to any type of diene elastomer, the present invention is preferably carried out using a diene elastomer of the highly unsaturated type.

This diene elastomer is more preferably selected from the group consisting of polybutadienes (BR), natural rubber (NR), synthetic polyisoprenes (IR), various butadiene copolymers, various isoprene copolymers and mixtures of these elastomers, such copolymers notably being selected from the group consisting of butadiene-stirene copolymers (SBRs), isoprene/butadiene copolymers (BIRs), isoprene/stirene copolymers (SIRs) and isoprene-butadiene-stirene copolymers (SBIRs).

One particularly preferred embodiment consists in using an “isoprene” elastomer, that is to say an isoprene homopolymer or copolymer, in other words a diene elastomer selected from the group consisting of natural rubber (NR), synthetic polyisoprenes (IRs), various isoprene copolymers and mixtures of these elastomers. The isoprene elastomer is preferably natural rubber or a synthetic polyisoprene of the cis-1,4 type. Among these synthetic polyisoprenes, use is preferably made of polyisoprenes having a content (mol of cis-1,4 bonds of greater than 90%, even more preferably greater than 98%. According to one preferred embodiment, each layer of rubber composition contains 50 to 100 phr of natural rubber. According to other preferred embodiments, the diene elastomer may consist, in full or in part, of another diene elastomer such as, for example, an SBR elastomer used as a blend with another elastomer, for example of the BR type, or used alone.

The elastomer matrix may contain a single diene elastomer or several diene elastomers, the latter possibly being used in combination with any type of synthetic elastomer other than a diene elastomer, or even with polymers other than elastomers. The rubber composition may also contain all or some of the additives usually employed in rubber matrixes intended for the manufacture of tires, such as, for example, reinforcing fillers such as carbon black or silica, coupling agents, anti-ageing agents, antioxidants, plasticizers or extension oils, whether the latter be of aromatic or nonaromatic nature (notably very weakly aromatic or non-aromatic oils, for example of the naphthene or paraffin type, of high or preferably low viscosity, MES or TDAE oils), plasticizing resins with a high Tg above 300° C., agents that improve the workability (processability) of the components in the raw state, tackifying resins, antireversion agents, methyl acceptors and donors such as HMT (hexamethylenetetramine) or H3M (hexamethoxymethylmelamine), reinforcing resins (such as resorcinol or bismaleimide), known adhesion promoting systems of the metallic salts type, for example, notably salts of cobalt, nickel or lanthanide, a crosslinking or vulcanization system.

Preferably, the system for crosslinking the elastomer matrix is a system referred to as a vulcanization system, that is to say one based on sulphur (or on a sulphur donor agent) and a primary vulcanization accelerator. Various known vulcanization activators or secondary accelerators may be added to this basic vulcanization system. Sulphur is used at a preferred content of between 0.5 and 10 phr, and the primary vulcanization accelerator, for example a sulphonamide, is used at a preferred content of between 0.5 and 10 phr. The content of reinforcing filler, for example of carbon black or silica, is preferably greater than 50 phr, especially between 50 and 150 phr.

All types of carbon black, notably blacks of the HAF, ISAF, SAF type conventionally used in tires (so-called tire-grade blacks) are suitable for use as carbon blacks. Among the latter, more particular mention will be made of carbon blacks of (ASTM) grade 300, 600 or 700 (for example N326, N330, N347, N375, N683, N772). Precipitated or pyrogenated silicas having a BET surface area of less than 450 m²/g, preferably from 30 to 400 m²/g are notably appropriate for use as silicas.

A person skilled in the art will know, in the light of the present description, how to adjust the formulation of the rubber composition in order to reach the desired levels of properties (especially elastic modulus) and adapt the formulation to suit the specific application envisaged.

For preference, the elastomer matrix has, in the crosslink state, a secant extension modulus at 10% elongation of between 4 and 80 MPa, more preferably of between 4 and 20 MPa. Modulus measurements are carried out under tension, unless otherwise indicated, in accordance with the standard ASTM D 412 of 1998 (test specimen “C”): the “true” secant modulus (that is to say the one with respect to the actual cross section of the test specimen) is measured in second elongation (that is to say after an accommodation cycle) at 10% elongation, denoted here by Ms and expressed in MPa (under standard temperature and relative humidity conditions in accordance with the standard ASTM D 1349 of 1999).

In one embodiment, each sidewall of the tire comprises a single knit comprising first and second zones. In another embodiment, each sidewall comprises at least two knits, each knit comprising first and second zones. In yet another embodiment, each sidewall of the tire comprises at least one set of at least two layers of a knit comprising the first and second zones, the two layers being at least partially superposed on one another.

In order to achieve the various properties of the knit, a person skilled in the art will know how to vary certain parameters of the knit such as the structure and certain parameters of the method used to manufacture the knit, such as the type of loom used, the gauge of the loom and the course count in the case of weft knits.

In one preferred embodiment, the tire comprises a carcass reinforcement anchored in two beads and surmounted radially by a crown reinforcement itself surmounted by a tread which is connected to the beads by two sidewalls, each sidewall comprising at least the knit.

By positioning the knit in the sidewall, the cornering stiffness of the tire is improved.

Thus, if the sidewall is pinched against the rim, the knit makes it possible to avoid damage to the carcass reinforcement.

For preference, the carcass reinforcement is anchored in each bead by being turned up around an annular structure of the bead so as to form a main strand and a turnup.

According to one optional feature, the radial distance between the radially inner end of the knit and the radially median plane of the annular structure of the bead is less than or equal to 15 mm, preferably less than or equal to 10 mm and more preferably less than or equal to 5 mm. The radially median plane is the plane that divides the annular structure into two parts of equal size in the radial direction.

According to another optional feature, the axial distance between the radially outer end of the knit and the axially outer end of a crown ply radially adjacent to the knit is less than or equal to 15 mm, preferably less than or equal to 10 mm, and more preferably less than or equal to 5 mm.

According to an optional feature of the first zone, this zone extends radially between first and second points of the first zone, the first point of the first zone being radially on the inside in relation to the second point of the first zone.

For preference, the first point of the first zone is radially on the inside in relation to the equator of the tire. The “equator” of the tire means the radial height of the point of greatest axial extension of the carcass reinforcement. In a radial cross section of the tire, the equator appears as the axial straight line passing through the points at which the carcass reinforcement is of greatest axial width when the tire is mounted on a rim and inflated. When the carcass reinforcement reaches this greatest axial width at a number of points, it is the radial height of the point closest to mid-height H/2 of the tire that is considered to be the equator of the tire. The equator defined in this way is not to be confused with the median plane of the tire.

More preferably still, the radial distance between the first point of the first zone and the radially median plane of the annular structure of the bead is less than or equal to 15 mm, preferably less than or equal to 10 mm, and more preferably less than or equal to 5 mm.

For preference, the second point of the first zone is radially on the inside in relation to the equator of the tire.

More preferably still, the radial distance between the second point of the first zone and the equator of the tire ranges from 3% to 10% of the section height of the tire.

The nominal aspect ratio, commonly referred to as the H/B ratio, is defined by the ETRTO (“European Tire and Rim Technical Organisation”). H is the section height of the tire and B is the width of the section of the tire, measured at the equator.

According to one optional feature of the tire, each first and second point of the first zone is radially on the outside in relation to the radially median plane of the annular structure of the bead.

According to an optional feature of the second zone, this zone extends radially between first and second points of the second zone, the first point of the second zone being radially on the inside in relation to the second point of the second zone.

For preference, the first point of the second zone is radially on the outside in relation to the equator of the tire.

More preferably still, the radial distance between the first point of the second zone and the equator of the tire ranges from 3% to 10% of the section height of the tire.

For preference, the axial distance between the second point of the second zone and the axially outer end of a crown ply radially adjacent to the second zone is less than or equal to 15 mm, preferably less than or equal to 10 mm, and more preferably less than or equal to 5 mm.

In one embodiment, the radially outer end of the knit is axially on the inside in relation to the axially outer end of a crown ply radially adjacent to the knit.

In another embodiment, the radially outer end of the knit is axially on the outside in relation to the axially outer end of a crown ply radially adjacent to the knit.

For preference, the radially outer end of the knit is interposed radially between the carcass reinforcement and the crown reinforcement.

In certain embodiments, the knit is arranged axially on the inside of the carcass reinforcement.

In one preferred embodiment, the knit forms a monolithic ring having an axis of revolution substantially parallel to the axis of the tire.

A monolithic ring means that each stitch of the knit is assembled with at least one other stitch of the knit. Thus, in a monolithic ring, there is no overlap between the two ends of the knit. Such a ring makes it possible to simplify the method of manufacture of the tire.

In one embodiment, the tire is for industrial vehicles selected from vans, heavy vehicles such as “heavy-duty vehicles”—i.e. underground trains, buses, road haulage vehicles (lorries, tractors, trailers), off-road vehicles, agricultural vehicles or civil engineering plant, aircraft, other transport or handling vehicles. In another embodiment, the tire is for a passenger vehicle. In yet another embodiment, the tire is for a two-wheeled vehicle.

A further subject of the invention is the use, for reinforcing a tire, of a knit comprising:
columns of loops, the loops of one and the same column being arranged one after the other substantially in an overall direction referred to as the main direction,
rows of loops, the loops of one and the same row being arranged one beside the other substantially in an overall direction referred to as the transverse direction, the knit comprising first and second zones each respectively having, at least in one of the main or transverse directions, a force FT₁₀₀ and FS₁₀₀ at 100% elongation that satisfies FS₁₀₀<FT₁₀₀, each force FT₁₀₀ and FS₁₀₀ being determined from a force-elongation curve obtained by applying standard ISO 13934-1:2013.

Another subject of the invention is a method of manufacturing a tire as defined hereinabove, in which the knit is embedded in an elastomer matrix.

The invention will be better understood from reading the description which follows, given solely by way of nonlimiting example and with reference to the drawings in which:

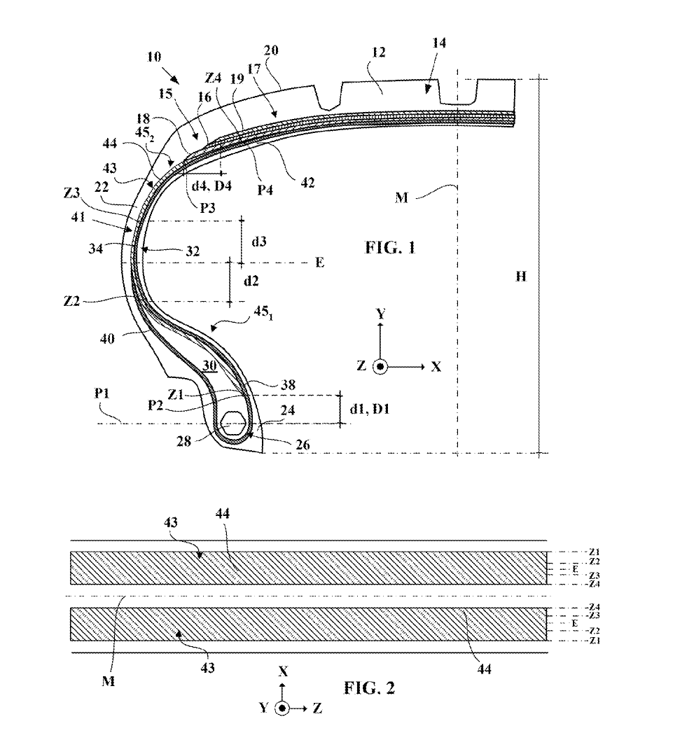

FIG. 1 is a view in cross section of a tire according to a first embodiment of the invention, comprising at least one knit;

FIG. 2 is a schematic development of the tire of FIG. 1, illustrating the axial distribution of knits;

FIG. 3 is a detailed view of a knit of the tire of FIG. 1;

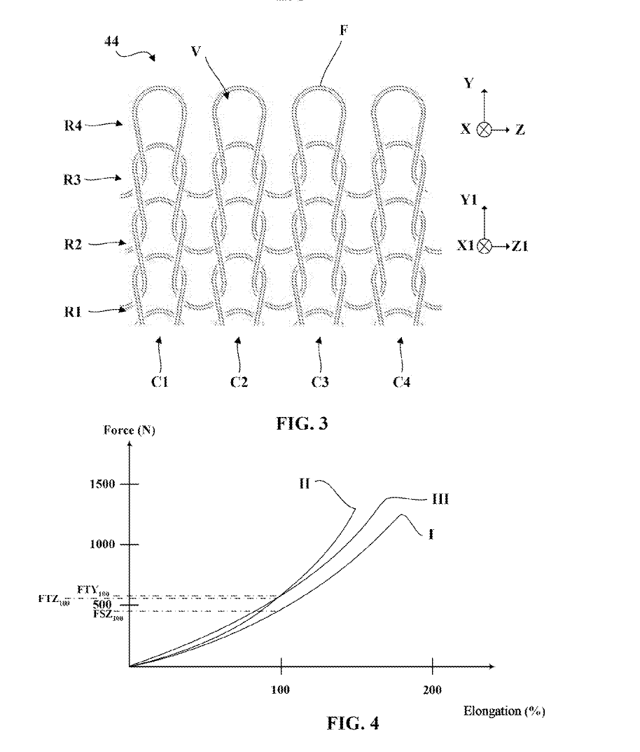

FIG. 4 is a graph illustrating force-elongation curves for the knit of FIGS. 1 to 3;

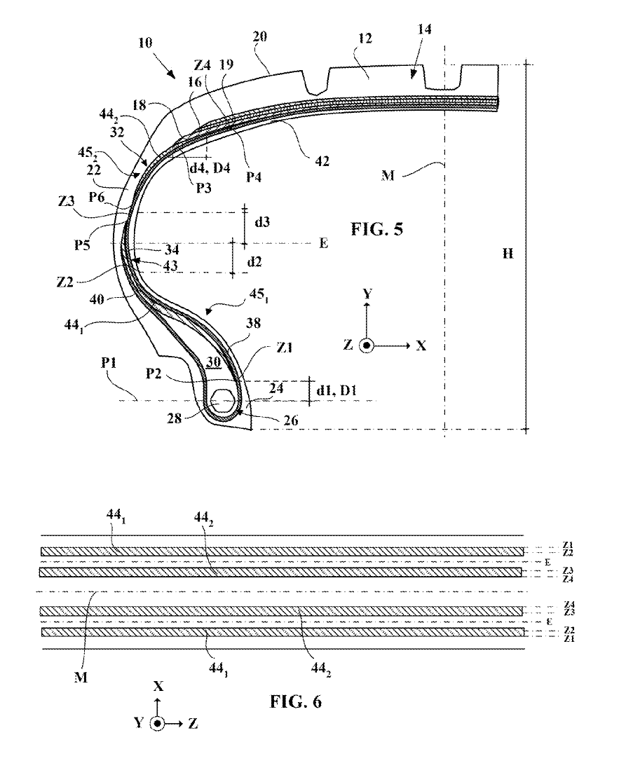

FIGS. 5 and 6 are views respectively similar to those of FIGS. 1, 2, of a tire according to a second embodiment;

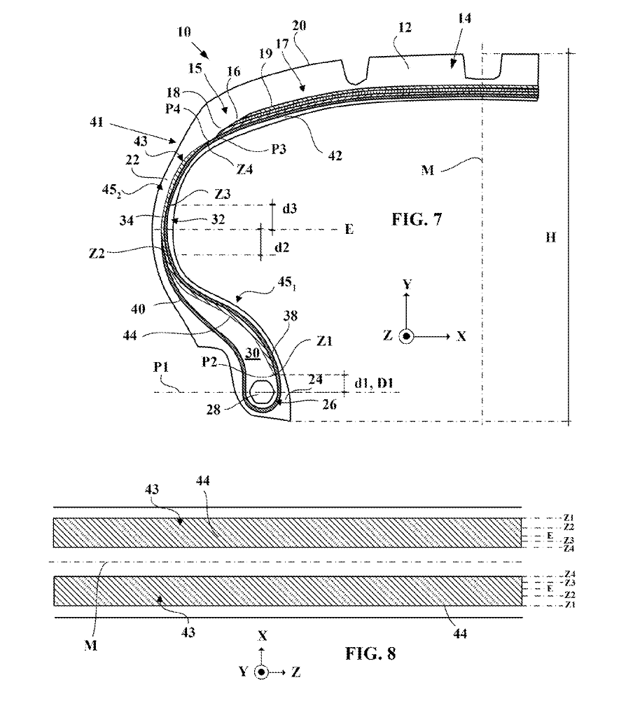

FIGS. 7 and 8 are views respectively similar to those of FIGS. 1, 2 of a tire according to a third embodiment; and

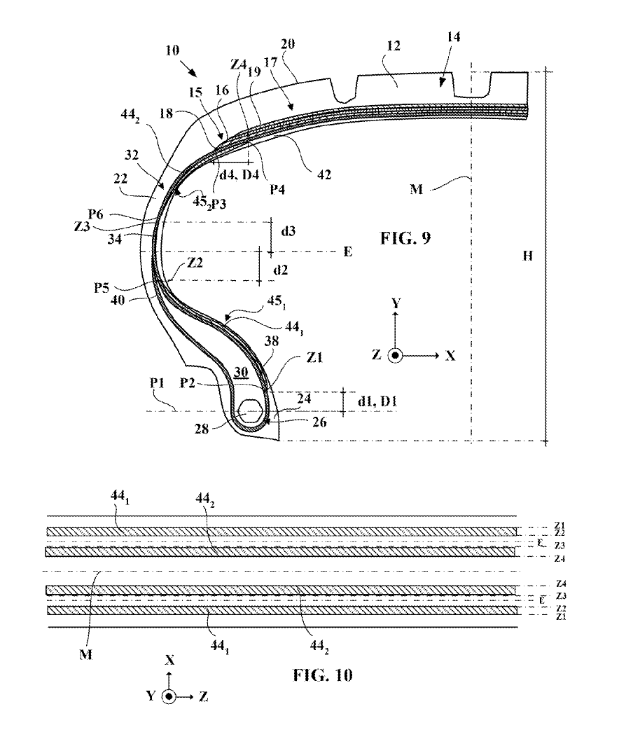

FIGS. 9 and 10 are views respectively similar to those of FIGS. 1, 2, of a tire according to a fourth embodiment.

In the following description, when using the word “radial”, it is appropriate to makes a distinction between several different uses of the word by a person skilled in the art. Firstly, the expression refers to a radius of the tire. It is in that sense that a point A is said to be “radially inside” a point B (or “radially on the inside of” the point B) if it is closer to the axis of rotation of the tire than is the point B. Conversely, a point C is said to be “radially outside” a point D (or “radially on the outside of” the point D) if it is further from the axis of rotation of the tire than is the point D. Progress “radially inwards (or outwards)” will mean progress toward smaller (or larger) radii. It is this sense of the word that applies also when radial distances are being discussed.

On the other hand, a reinforcing element or reinforcement is said to be “radial” when the reinforcing element or the reinforcing elements of the reinforcement make an angle greater than or equal to 65° and less than or equal to 90° with the circumferential direction.

An “axial” direction is a direction parallel to the axis of rotation of the tire. A point E is said to be “axially inside” a point F (or “axially on the inside of” the point F) if it is closer to the median plane of the tire than is the point F. Conversely, a point G is said to be “axially outside” a point H (or “axially on the outside of” the point H) if it is further from the median plane of the tire than is the point H.

The “median plane” M of the tire is the plane which is normal to the axis of rotation of the tire and which is situated equidistantly from the annular reinforcing structures of each bead.

A “circumferential” direction is a direction which is perpendicular both to a radius of the tire and to the axial direction.

Furthermore, any range of values denoted by the expression “between a and b” represents the range of values extending from more than a to less than b (namely excluding the end-points a and b), whereas any range of values denoted by the expression “from a to b” means the range of values extending from the end-point “a” as far as the end-point “b”, namely including the strict end-points “a” and “b”.

### Examples of Tires According to the Invention

A frame of reference X, Y, Z, corresponding to the usual respectively axial (X), radial (Y) and circumferential (Z) directions of a tire has been depicted in the figures.

FIGS. 1 and 2 depict a tire according to a first embodiment of the invention and denoted by the general reference 10. The tire 10 is substantially of revolution about the axis X. The tire 10 here is intended for a passenger vehicle. The tire depicted is of size 205/55 R 16.

The tire 10 comprises a crown 12 comprising a crown reinforcement 14 comprising a working reinforcement 15 comprising two working layers 16, 18 of reinforcing elements and a protective or hoop reinforcement 17 comprising a protective ply 19. The crown reinforcement 14 is surmounted by a tread 20. In this instance, the protective reinforcement 17, in this instance the protective ply 19, is interposed radially between the working reinforcement 15 and the tread 20.

Two sidewalls 22 extend the crown 12 radially inwards. The tire 10 further comprises two beads 24 radially on the inside of the sidewalls 22 and connected to the crown 12 by the sidewalls 22 and each comprising an annular reinforcing structure 26, in this instance a bead wire 28, surmounted by a mass of filling rubber 30, as well as a radial carcass 32. The carcass reinforcement 32 is surmounted radially by the crown reinforcement 14.

The carcass reinforcement 32 preferably comprises a single carcass ply 34 of radial textile reinforcing elements, the ply 34 being anchored in each of the beads 24 by being turned up around the bead wire 28 so as to form, within each bead 24, a main strand 38 extending from the beads 24 through the sidewalls 22 to the crown 12, and a turnup 40, the radially outer end of the turnup 40 here being substantially midway up the height of the tire 10. The carcass reinforcement 32 thus extends from the beads 24 through the sidewalls 22 to the crown 12. As an alternative, the radial reinforcing elements are made of metal. The tire 10 also comprises an inner liner 42, generally made of butyl, arranged axially and radially on the inside of the carcass reinforcement 32.

The working plies 16, 18 comprise metal or textile reinforcing elements conventional to a person skilled in the art and forming an angle from 15° to 40°, preferably ranging from 20° to 30° and here equal to 26° with the circumferential direction Z of the tire. The reinforcing elements of the working plies are crossed from one working ply to the other.

The protective ply 19 comprises metal or textile reinforcing elements likewise conventional to a person skilled in the art and forming an angle ranging from 0° to 10° with the circumferential direction Z of the tire.

Furthermore, the tire comprises an additional reinforcement 41, comprising at least one additional ply 43. Each additional ply 43 comprises at least one knit 44. The additional ply 43 and, in this instance, the knit 44, are arranged axially on the outside of the carcass reinforcement 34. Thus, as illustrated in FIG. 1, each sidewall 22 comprises a knit 44.

The radially outer end P4 of the knit 44 is axially on the inside in relation to the axially outer end P3 of the crown ply 18 radially adjacent to the knit 44. Furthermore, the radially outer end P4 of the knit 44 is interposed radially between the carcass reinforcement 32 and the crown reinforcement 14.

The axial distance D4 between the radially outer end P4 of the knit 44 and the axially outer end P3 of the crown ply 18 radially adjacent to the knit 44 is less than or equal to 15 mm, preferably less than or equal to 10 mm, and more preferably less than or equal to 5 mm. Here, D4=5 mm.

The knit 44 extends, in the bead, axially between the main strand 38 and the turnup 40 of the carcass reinforcement 32. As an alternative, it is possible to conceive of an embodiment in which the knit extends, in the bead, axially on the outside of the turnup 40.

The radial distance D1 between the radially inner end P2 of the knit 44 and the radially median plane P1 of the annular structure 26 of the bead 24 is less than or equal to 15 mm, preferably less than or equal to 10 mm, and more preferably less than or equal to 5 mm. Here, D1=5 mm.

Each working ply 16, 18, protective ply 19, carcass ply 34 and additional ply 43 comprises an elastomer matrix in which the reinforcing elements of the corresponding ply are embedded. The compositions of the elastomer matrixes of the working plies 16, 18, protective ply 19, carcass ply 34 and additional ply 43 are compositions that are conventional for skimming reinforcing elements and contain in the conventional way a diene elastomer, for example natural rubber, a reinforcing filler, for example carbon black and/or silica, a crosslinking system, for example a vulcanization system, preferably containing sulphur, stearic acid and zinc oxide, and possibly a vulcanization retardant and/or accelerator and/or various additives.

FIG. 3 depicts the knit 44. The knit 44 comprises columns C1, C2, C3, C4 of loops V and rows R1, R2, R3, R4 of loops V. The loops V of one and the same column Ci are arranged one after another substantially in an overall direction referred to as the main direction Y1. The loops V of one and the same row Ri are arranged one beside the other substantially in an overall direction referred to as the transverse direction Z1.

The main Y1 and transverse Z1 directions make, with respect to one another, an angle of between 75° and 105°, preferably between 85° and 95°. Here, the main Y1 and transverse Z1 directions are substantially perpendicular to one another.

The main overall direction Y1 makes an angle at most equal to 30° with the radial direction Y of the tire 10. When the knit is laid on a flat support, the main overall direction Y1 makes an angle here equal to 0° with the radial direction Y of the tire 10, the main overall direction Y1 of the knit 44 being essentially parallel to the radial direction Y of the tire 10.

The transverse overall direction Z1 makes an angle at most equal to 10° with the circumferential direction Z of the tire 10 and in this instance makes an angle equal to 0°, the transverse overall direction Z1 of the knit 44 being substantially parallel to the circumferential direction Z of the tire 10.

The knit 44 has a construction of the jersey type and has been produced using a knitting method conventional to those skilled in the art in this field. The knit 44 has, in the direction Y1, a thickness ranging from 0.7 to 3 mm, preferably 0.8 to 2.6 mm, and here equal to 1.6 mm.

The number of stitches of the knit per unit area, measured in accordance with standard NF EN 14971, is less than or equal to 700 stitches·cm⁻², preferably less than or equal to 100 stitches·cm⁻² and more preferably less than or equal to 75 stitches·cm⁻². The number of knit stitches per unit area is also greater than or equal to 5 stitches·cm⁻², preferably greater than 10 stitches·cm⁻² and more preferably, greater than or equal to 15 stitches·cm⁻². In this particular instance, the density of stitches per unit area is equal to 15 stitches·cm⁻².

The tire 10 comprises a first zone 45₁ and a second zone 45₂ of the knit 44. Referring back to FIGS. 1 and 2, the first zone 45₁ of the knit 44 has a radius of curvature smaller than the radius of curvature of the second zone 45₂ of the knit 44. The second zone 45₂ is arranged radially on the outside of the first zone 45₁.

The first zone 45₁ differs from the second zone 45₂ in terms of at least one feature selected from the construction, the stitch size, the linear density of columns of stitches as measured in accordance with standard NF EN 14971, the linear density of rows of stitches as measured in accordance with standard NF EN 14971, the surface density of stitches as measured in accordance with standard NF EN 14971, or a combination of these features. In this particular instance, the first and second zones 45₁, 45₂ differ from one another in terms of the linear density of rows of stitches and therefore also in terms of the number of stitches per unit area (the linear density of columns of stitches being the same in both the first and second zones 45₁, 45₂).

FIG. 4 depicts force-elongation curves obtained by applying standard ISO 13934-1:2013 to the knit before it is incorporated into the tire. In this instance, the knit has no elastomer matrix.

Curve I illustrates the variation in force as a function of the elongation of the second zone 45₂ of the knit 44 in the transverse direction Z1. Curve II illustrates the variation in force as a function of the elongation of the first zone 45₁ of the knit 44 in the transverse direction Z1. Curve III illustrates the variation in force as a function of elongation of the knit in the main direction Y1.

As can be seen from FIG. 4, the knit 44 has particular properties of elongation at break and of maximum force which are measured in accordance with standard ISO 13934-1:2013, and properties of force at 50% and 100% elongation which are determined from a force-elongation curve obtained by applying standard ISO 13934-1:2013 to the knit 44 before it is incorporated into the tire 10.

Each first and second zone 45₁,45₂ has, in the main direction Y1, in this instance the radial direction Y of the tire 10, a force at 100% elongation denoted FTY₁₀₀ and FSY₁₀₀ respectively, each force FTY₁₀₀ and FSY₁₀₀ being determined from a force-elongation curve obtained by applying standard ISO 13934-1:2013. However, only the force-elongation curve for the first zone 45₁ has been reproduced, with FTY₁₀₀=549 N.

Each first and second zone 45₁, 45₂ has, in the transverse direction Z1, in this instance the circumferential direction Z of the tire, a force at 100% elongation respectively denoted FTZ₁₀₀ and FSZ₁₀₀ that satisfies FSZ₁₀₀<FTZ₁₀₀, each force FTZ₁₀₀ and FSZ₁₀₀ being determined from a force-elongation curve obtained by applying the standard ISO 13934-1:2013. Here, FT₁₀₀=FTZ₁₀₀=542 N and FS₁₀₀=FSZ₁₀₀=462 N. We therefore have an FZT₁₀₀ and FSZ₁₀₀ that satisfy FT₁₀₀/FS₁₀₀>1.05, preferably FT₁₀₀/FS₁₀₀>1.10 and more preferably FT₁₀₀/FS₁₀₀>1.15 and FT₁₀₀/FS₁₀₀<2.00, preferably FT₁₀₀/FS₁₀₀<1.80 and more preferably FT₁₀₀/FS₁₀₀<1.60. Here, FT₁₀₀/FS₁₀₀=1.17.

The knit 44 is made up of one or more filamentary elements F of a nonelastomeric material. The or each nonelastomeric material is selected from a polyester, a polyamide, a polyketone, a cellulose, a mineral fibre, a natural fibre or a mixture of these materials.

The or each filamentary element F comprises at least one multifilament strand comprising several elementary monofilaments. In this particular instance, the or each filamentary element E comprises two strands of nylon each of 140 tex each overtwisted at 250 turns·m⁻¹ in a first direction then plied in a helix around one another at 250 turns·m⁻¹ in a second direction that is the opposite of the first direction.

The first zone 45₁ extends radially between first and second points Z1, Z2 of the first zone 45₁. The first point Z1 is radially on the inside in relation to the second point Z2. The first point Z1 is also radially on the inside in relation to the equator E of the tire 10. The second point Z2 is radially on the inside in relation to the equator E of the tire 10. Each first and second point Z1, Z2 is radially on the outside in relation to the radially median plane P1 of the annular structure 26 of the bead 24.

The radial distance d1 between the first point Z1 and the radially median plane P1 of the annular structure 26 of the bead 24 is less than or equal to 15 mm, preferably less than or equal to 10 mm, and more preferably less than or equal to 5 mm. Here, d1=D1=5 mm.

The radial distance d2 between the second point Z2 and the equator E of the tire 10 ranges from 3% to 10% of the section height H of the tire 10. Here H=112.75 mm and d2=7 mm.

The second zone 45₂ extends radially between first and second points Z3, Z4 of the second zone 45₂. The first point Z3 of the second zone 45₂ is radially on the inside in relation to the second point Z4 of the second zone 45₂. The first point Z3 of the second zone 45₂ is radially on the outside in relation to the equator E of the tire 10.

The radial distance d3 between the first point Z3 of the second zone 45₂ and the equator E of the tire 10 ranges from 3% to 10% of the section height H of the tire 10. Here H=112.75 mm and d3=7 mm.

The axial distance d4 between the second point Z4 of the second zone 45₂ and the axially outer end P3 of a crown ply 18 radially adjacent to the second zone 45₂ is less than or equal to 15 mm, preferably less than or equal to 10 mm, and more preferably less than or equal to 5 mm. Here, d4=D4=5 mm.

A method of manufacturing the tire as described hereinabove will now be described. Only the main steps relating to the invention will be described, it being easy for the other steps to be carried out on the basis of the general knowledge of a person skilled in the art.

During the course of the method, a green tire comprising the beads 24, the sidewalls 22 and the carcass reinforcement 32, in this instance the carcass ply 34, is formed.

In a first alternative form of the method, the knit 44 is embedded in its elastomer matrix so as to obtain the additional ply 43, for example by skimming the knit 44 between two strips of elastomer matrix. This additional ply 43 is then added to the green tire formed beforehand. Next, the crown reinforcement 14 and the tread 20 are added.

In a second alternative form, a first strip of elastomer matrix is added to the green tire. Then, the knit 44 is added to the first strip of elastomer matrix. Next, a second strip of elastomer matrix is added to the knit 44. Finally, the crown reinforcement 14 and the tread 20 are added. When the green tire is cured to form the tire 10, the elastomer matrix of the first and second strips flows through the knit 44. Thus the knit 44 becomes embedded in its elastomer matrix.

In this second alternative form, the knit 44 forms a monolithic ring having an axis of revolution. The ring is radially deformable, namely deformable at right angles to its axis of revolution, between a position at rest and a deformed position. Thus, the knit 44 is deformed radially from its state at rest into its deformed state then added axially around the green tire in its deformed state, then the knit 44 is released from its deformed state so that the knit tightly encircles the green tire. Once in position on the green tire, the axis of revolution of the monolithic ring is substantially parallel to and coincident with the axis of the tire.

Second, third and fourth embodiments of the invention will now be described with reference respectively to FIGS. 5, 6 and 7, 8 and 9, 10. Elements similar to those described in the previous embodiment are denoted by identical references.

The tire according to the second embodiment in FIGS. 5 and 6 comprises two knits 441 and 442. The knit 441 comprises a radially inner end denoted P2 and a radially outer end P5. The knit 442 comprises a radially inner end denoted P6 and a radially outer end P4. Each knit 441 and 442 comprises first and second zones 45_{1,1}, 45_{1,2} and 45_{2,1}, 45_{2,2}, respectively.

Unlike the tire according to the first embodiment, the tire according to the third embodiment in FIGS. 7 and 8 is such that the radially outer end P4 of the knit 44 is axially on the outside in relation to the axially outer end P3 of the crown ply 18 radially adjacent to the knit 44.

Unlike the tire according to the second embodiment in FIGS. 5 and 6, the tire of the fourth embodiment in FIGS. 9 and 10 comprises two knits 441, 442, in this instance the knits of the second embodiment, arranged axially on the inside of the carcass reinforcement 32.

Comparative Tests

In addition to reducing the difference in capacity to reinforce and to elongate between various zones of the knit which capacity is generated during the shaping of the tire, the tire according to the invention offers an excellent compromise between mass and cornering stiffness under heavy loading.

The tire 10 according to the invention and three tires T1, T2 and T3 of the prior art were compared. The tire 10 has an architecture identical to the tire according to the first embodiment and comprises a knit made up of one or more filamentary elements of a nonelastomeric material, in this instance nylon.

The characteristics of the knit 44 used are described in tables 1 (properties relating to maximum force, force at break, elongation at 50% and 100% in accordance with standard ISO 13934-1:2013 applied to the knit prior to its incorporation into the tire) and 2 (properties relating to the linear density of rows of stitches, linear density of columns of stitches, surface density of stitches per unit area, in accordance with standard NF EN 14971 of 2006) below.

TABLE 1

| | Tire | | |
|---|---|---|---|
| | 10 | | |
| | | Transverse | Transverse |
| | Main direction Y1 - | direction Z1 - | direction Z1 - |
| | first zone 45₁ | first zone 45₁ | second zone 45₂ |
| Curve (FIG. 4) | III | II | I |
| Nature of the | N94/2 | N94/2 | N94/2 |
| strand | | | |
| Construction | Welted jersey | Welted jersey | Welted jersey |
| of the knit | | | |
| Maximum | 1391 | 1320 | 1297 |
| force (N) | | | |
| Elongation at | 167 | 152 | 182 |
| break (%) | | | |
| Force at 100% | 549 | 542 | 462 |
| elongation | | | |
| Force at 50% | 148 | 48.1 | 39.1 |
| elongation | | | |

TABLE 2

Tire
10

| | First zone 45₁ | Second zone 45₂ |
|---|---|---|
| Nature of the | N94/2 | N94/2 |
| strand | | |
| Construction of the | Welted jersey | Welted jersey |
| knit | | |
| Method used in | B | B |
| Standard NF EN | | |
| 14971 | | |
| Measurement face | Technical right side | Technical right side |
| Mean of individual | 3.0 | 3.0 |
| results | | |
| (columns/cm) | | |
| Mean of individual | 5.2 | 4.8 |
| results (rows/cm) | | |
| Surface density | 15.6 | 14.4 |
| (stitches/cm²) | | |

The tire T1 is identical to the tire 10 except that it has no knit. The tire T2 comprises, in addition to the elements of the tire T1, a second carcass ply. The tire T3 is identical to the tire T1 except that its sidewalls have an additional thickness of 10 mm by comparison with that of the sidewalls of the tire T1.

The various tires T1 to T3 and 10 were subjected to a drift thrust Dz test as described hereinbelow. The mass of each tire T1 to T3 and 10 was also measured.

The results are given to base 100 with respect to the tire T1. Thus, for drift thrust Dz, the greater the extent to which the value is above 100, the better the drift thrust of the tire tested compared with the tire T1. In the case of mass, the greater the extent to which the value is lower than 100, the heavier the tire tested is in relation to the tire T1.

To measure the drift thrust Dz, each tire was driven at a constant speed of 80 km/h on a suitable automatic machine (machine of the “flat track” type marketed by MTS), varying the load denoted “Z” at a relatively large cornering angle of 8 degrees, and the drift thrust was measured continuously and the cornering stiffness denoted “D” (corrected for the thrust at zero drift) was identified by recording, by way of sensors, the transverse load on the wheel as a function of this load Z; the cornering stiffness is thus obtained. The reported value for Dz is thus obtained for a chosen load here of 482 daN.

The results of these tests are collated in table 3 below.

TABLE 3

Tire

| | T1 | T2 | T3 | 10 |
|---|---|---|---|---|
| Weight (base 100) | 100 | 93 | 81 | 96 |
| Dz (base 100) | 100 | 100 | 108 | 105 |

It will be noted that the tire 10 according to the invention has a mass relatively similar to that of the tire T1 and, in any event, lower than that of the tire T2 and especially that of the tire T3. Furthermore, it will be noted that the tire 10 according to the invention has a cornering stiffness Dz higher than those of the tires T1 and T2. Thus, the tire 10 according to the invention offers a better compromise between mass and cornering stiffness than do the tires T1 to T3.

The advantages described hereinabove are obviously on top of the main advantage connected with the invention namely that of reducing the difference in the capacity to reinforce and to elongate of the various zones of the knit which capacity is generated during the shaping of the tire.

The invention is not limited to the embodiments described hereinabove.

It may also be possible to combine the features of the various embodiments described or envisaged above, as long as these are compatible with one another.

1. A tire including a knit comprising:
columns of loops, the loops of one and the same column being arranged one after the other substantially in an overall direction referred to as the main direction;
rows of said loops, the loops of one and the same row being arranged one beside the other substantially in an overall direction referred to as the transverse direction;
the knit comprising first and second zones each respectively having, at least in one of the main or transverse directions, a force FT₁₀₀ and FS₁₀₀ at 100% elongation that satisfies FS₁₀₀<FT₁₀₀, each force FT₁₀₀ and FS₁₀₀ being determined from a force-elongation curve obtained by applying standard ISO 13934-1:2013 to the knit before it is incorporated into the tire.

2. The tire according to claim 1, wherein the first zone of the knit has a radius of curvature less than the radius of curvature of the second zone of the knit.

3. The tire according to claim 1, wherein the second zone is arranged radially on the outside of the first zone.

4. The tire according to claim 1, wherein each force FT₁₀₀ and FS₁₀₀ at 100% elongation of each first and second zone is measured in a direction of the knit that is substantially parallel to the circumferential direction of the tire.

5. The tire according to claim 1, wherein the first zone differs from the second zone in terms of at least one feature selected from the construction, the stitch size, the linear density of columns of stitches as measured in accordance with standard NF EN 14971, the linear density of rows of stitches as measured in accordance with standard NF EN 14971, the surface density of stitches as measured in accordance with standard NF EN 14971, or a combination of these features.

6. The tire according to claim 1, comprising a carcass reinforcement anchored in two beads and surmounted radially by a crown reinforcement itself surmounted by a tread which is connected to the beads by two sidewalls, each sidewall comprising at least the knit.

7. The tire according to claim 6, wherein the carcass reinforcement is anchored in each bead by being turned up around an annular structure of the bead so as to form a main strand and a turn up.

8. The tire according to claim 7, wherein the radial distance between the radially inner end of the knit and the radially median plane of the annular structure of the bead is less than or equal to 15 mm.

9. The tire according to claim 6, wherein the axial distance between the radially outer end of the knit and the axially outer end of a crown ply radially adjacent to the knit is less than or equal to 15 mm.

10. The tire according to claim 9, wherein the first zone extends radially between first and second points of the first zone, the first point of the first zone being radially on the inside in relation to the second point of the first zone.

11. The tire according to claim 10, wherein the first point of the first zone is radially on the inside in relation to the equator of the tire.

12. The tire according to claim 11, wherein the radial distance between the first point of the first zone and the radially median plane of the annular structure of the bead is less than or equal to 15 mm.

13. The tire according to claim 10, wherein the second point of the first zone is radially on the inside in relation to the equator of the tire.

14. The tire according to claim 13, wherein the radial distance between the second point of the first zone and the equator of the tire ranges from 3% to 10% of the section height of the tire.

15. The tire according to claim 10, wherein each first and second point of the first zone is radially on the outside in relation to the radially median plane of the annular structure of the bead.

16. The tire according to claim 1, wherein the second zone extends radially between first and second points of the second zone, the first point of the second zone being radially on the inside in relation to the second point of the second zone.

17. The tire according to claim 16, wherein the first point of the second zone is radially on the outside in relation to the equator of the tire.

18. The tire according to claim 17, wherein the radial distance between the first point of the second zone and the equator of the tire ranges from 3% to 10% of the section height of the tire.

19. The tire according to claim 16, wherein the axial distance between the second point of the second zone and the axially outer end of a crown ply radially adjacent to the second zone is less than or equal to 15 mm.

20. The tire according to claim 16, wherein the radially outer end of the knit is axially on the inside in relation to the axially outer end of a crown ply radially adjacent to the knit.

21. The tire according to claim 16, wherein the radially outer end of the knit is axially on the outside in relation to the axially outer end of a crown ply radially adjacent to the knit.

22. The tire according to claim 6, wherein the radially outer end of the knit is interposed radially between the carcass reinforcement and the crown reinforcement.

23. (canceled)

24. A method of manufacturing a tire according to claim 1, wherein the knit is embedded in an elastomer matrix.
